(19) United States
(12) Patent Application Publication
(10) Pub. No.: US 2009/0272366 A1
(43) Pub. Date: Nov. 5, 2009

(54) Internal combustion engine set up method and fuel pump having installation assist mechanism

(75) Inventors: Scott Shafer, Morton, IL (US); Christopher R. Jones, Peoria, IL (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: Caterpillar Inc.

(21) Appl. No.: 12/150,635

(22) Filed: Apr. 30, 2008

(51) Int. Cl. F02M 37/22

(52) U.S. Cl. 123/509; 123/456

(57) ABSTRACT

A method of setting up a common rail internal combustion engine system includes setting a fuel pump for a common rail of the engine system at a configuration where a camshaft of the fuel pump is rotationally stable. The rotationally stable configuration may be a configuration where forces acting on the camshaft are balanced. The engine may then be set in an engine timing state which is accordant with the pump configuration, and the pump installed on the engine when in its first configuration and when the engine is at the engine timing state. The pump may be designed such that it has an installation assist mechanism which obviates the need for specialized tools or set up strategies to install the fuel pump on the engine with a correct timing.

### TECHNICAL FIELD

The present disclosure relates generally to fuel pumps and installation strategies for fuel pumps in internal combustion engine systems, and relates more particularly to setting an asynchronous timing between a fuel pump and an engine during installation of the fuel pump on the engine.

### BACKGROUND

It is typically desirable to set different components of an internal combustion engine system at specified timings relative to one another. For instance, engine operating strategies often dictate a certain timing between an engine crankshaft and one or more camshafts. If the timing is not set as specified, certain engine events may take place at a timing relative to other engine events which is inappropriate. These concerns may be particularly acute in some fuel systems for internal combustion engines.

It has become commonplace for internal combustion engines, and in particular diesel engines, to utilize a mechanism known in the art as a common rail. A typical common rail fuel system includes a rail which contains fuel at a relatively high pressure. The rail is connected with a plurality of fuel injectors, associated one with each of a plurality of engine cylinders. When fuel injection into one of the engine cylinders is desired, one of the fuel injectors coupled with the common rail may be actuated to spray fuel into the corresponding engine cylinder. A fuel pump is typically driven via engine rotation and replenishes fuel as it is consumed from the common rail. One goal associated with many common rail fuel systems is maintaining a fuel pressure within the rail at a stable level. To this end, engineers have experimented with a wide variety of strategies for maintaining and controlling rail pressure. Common strategies have included attempts to set a timing of the fuel pump relative to an engine timing such that fuel pressure drops in the rail are compensated for via pumping strokes of the fuel pump. In other words, many strategies attempt to set the fuel pump in phase with certain engine events. Regardless of the specific approach, to successfully maintain or control common rail pressure, it is typically necessary to time the fuel pump with relatively great precision relative to a timing of the engine.

When an internal combustion engine system is assembled and set up for initial service, an appropriate timing between an engine and a fuel pump for the engine is typically set. Over the course of the many years of an engine's service life, it may be necessary to remove a fuel pump from the engine for servicing or for installing replacement parts, upgraded parts, etc., also requiring the timing to be set. In either of these instances, technicians are often expected to undertake a relatively laborious process of timing the fuel pump relative to the engine. One conventional strategy is to lock the fuel pump at a given orientation, remove the fuel pump from the engine, service the engine, then reinstall the fuel pump at the locked orientation. Other strategies attempt to use relatively unwieldy and specialized tools to set the fuel pump at a specific timing which corresponds to a known timing state of the engine. In either case, fuel pump installation and timing set-up in many internal combustion engine systems could be improved.

U.S. Pat. No. 5,845,397 to Reedy et al. is directed to one timing strategy for use in heavy duty diesel engines. In the strategy proposed by Reedy et al., a crankshaft and camshaft are locked into predetermined rotational positions to set a desired timing between the crankshaft and camshaft. The camshaft is stated to be locked into its predetermined rotational position using a camshaft timing member positioned between a flat portion on an outer surface of the camshaft and an adjacent portion of the engine, such as the cylinder head. Positioning the camshaft as described via the timing member purportedly locks the camshaft into a desired rotational position for setting its timing with respect to the crankshaft. While the proposal set forth in Reedy et al. may have certain applications, it requires specialized hardware and is relatively labor intensive.

### SUMMARY

In one aspect, a method of setting up a common rail internal combustion engine system for operation includes a step of setting a fuel pump for a common rail of the engine system at a pump configuration where a camshaft of the fuel pump is rotationally stable. The method further includes the steps of placing an engine of the engine system at an engine timing state which is accordant with the pump configuration, and installing the fuel pump on the engine when the fuel pump is in the pump configuration and the engine is at the engine timing state. The method still further includes a step of setting a timing between the engine and the fuel pump at an asynchronous timing at least in part via the installing step.

In another aspect, an electronically controlled variable displacement fuel pump for a common rail fuel system of an internal combustion engine includes a housing having a fuel inlet and a fuel outlet, and a metering valve associated with the housing and configured to vary an output of the fuel pump to a common rail. The fuel pump further includes a camshaft having a plurality of cams, a plurality of plungers and a plurality of biasers each biasing one of the plurality of plungers toward interaction with one of the plurality of cams. The fuel pump has a pump configuration where the camshaft is rotationally stable, and the fuel pump further includes an installation assist mechanism which includes the plurality of biasers and the plurality of cams and is configured to bias the fuel pump toward the pump configuration.

In still another aspect, a method of reducing timing errors of a fuel pump in a common rail engine system includes the steps of biasing the fuel pump toward a pump configuration where a camshaft of the fuel pump is rotationally stable, and placing an engine at an engine timing state which is accordant with the pump configuration. The method further includes the steps of installing the fuel pump on the engine when the fuel pump is in the pump configuration and the engine is at the engine timing state, and setting a timing between the engine and the fuel pump at an asynchronous timing at least in part via the installing step.

### BRIEF DESCRIPTION OF THE DRAWINGS

FIG. 1 is a partially sectioned side diagrammatic view of an engine system, according to one embodiment;

FIG. 2 is a partially sectioned side diagrammatic view of components of a fuel pump, according to one embodiment; and

FIG. 3is a graph illustrating engine phasing versus pump phasing, according to one embodiment.

### DETAILED DESCRIPTION

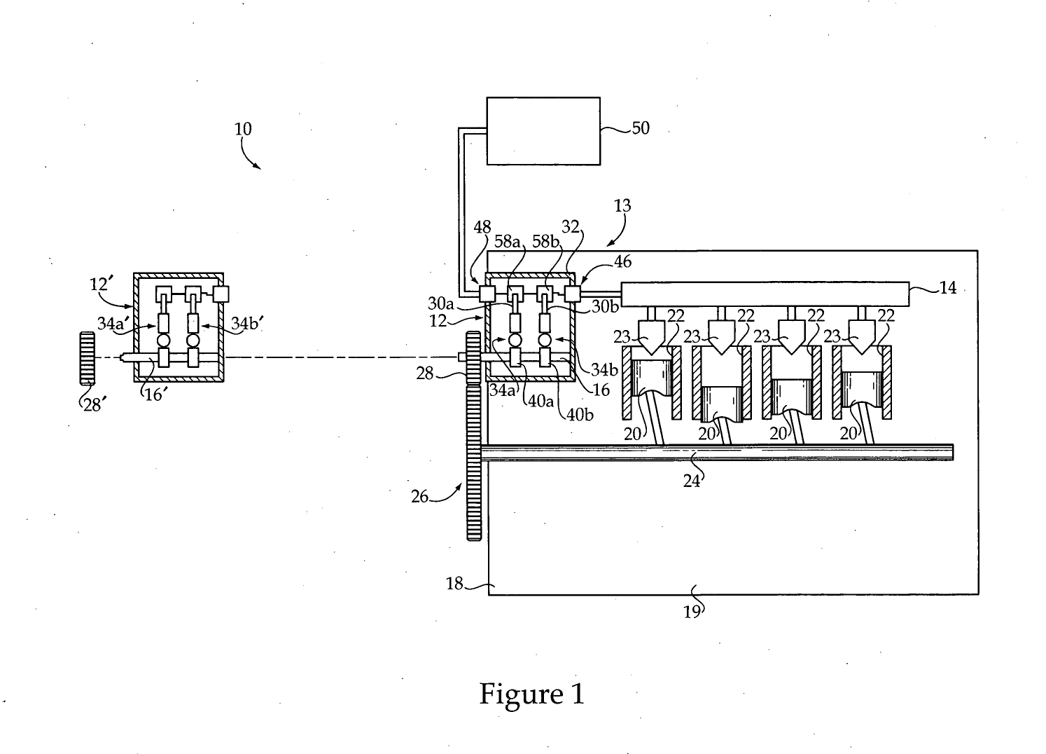

Referring to FIG. 1, there is shown an engine system 10 according to one embodiment. Engine system 10 may include an engine 18 having an engine housing 19 with a plurality of cylinders 22 therein. A plurality of pistons 20 may be provided which are associated one with each of cylinders 22 and reciprocable therein. Each of pistons 20 may be coupled with a crankshaft 24 which is in turn coupled with a geartrain 26 in a conventional manner. Engine system 10 may further include a fuel system 13 which includes a low pressure fuel supply 50 connecting with a fuel pump 12 installed on engine 18 and having a pump gear 28 which meshes with geartrain 26. Fuel system 13 may further include a common rail 14 which receives pressurized fuel from fuel pump 12, and supplies pressurized fuel to each of a plurality of fuel injectors 23, associated one with each of cylinders 22. In one embodiment, engine system 10 may include a direct injection compression ignition diesel engine system. In other embodiments, spark ignited engines, port injected engines, or some other engine system configuration might be used. As will be further apparent from the following description, engine system 10 may be configured such that it may be readily set up for operation at an appropriate timing between fuel pump 12 and engine 18, during installation of fuel pump 12 on engine 18. In FIG. 1, fuel pump 12 is shown in an installed state where it is installed on engine 18 and mounted to housing 19, for example. Fuel pump 12 is also shown in FIG. 1 in an uninstalled state, denoted via reference numeral 12′. Other references numerals, including 16′, 28′, 34a′ and 34b′, identify corresponding components in the uninstalled state, as further described herein.

In one embodiment, fuel pump 12 may include a reciprocating fuel pump which is actuated via rotation of a camshaft 16 coupled with pump gear 28. Camshaft 16 may include a plurality of cams, including a first cam 40a and a second cam 40b. A first lifter-roller assembly 34a is associated with first cam 40a, and a second lifter-roller assembly 34b is associated with second cam 40b. Rotation of camshaft 16 can actuate lifter-roller assemblies 34a and 34b to reciprocate a first plunger 30a and a second plunger 30b, respectively. Fuel pump 12 may further include a pump housing 32 which includes a fuel inlet 48 connecting with low pressure fuel supply 50, and a fuel outlet 46 which connects with common rail 14 in a conventional manner. Housing 32 may further define a first pump chamber 58a and a second pump chamber 58b, and plungers 30a and 30b may be reciprocable at least partially within pump chambers 58a and 58b, respectively, to pressurize fuel therein for supplying to common rail 14.

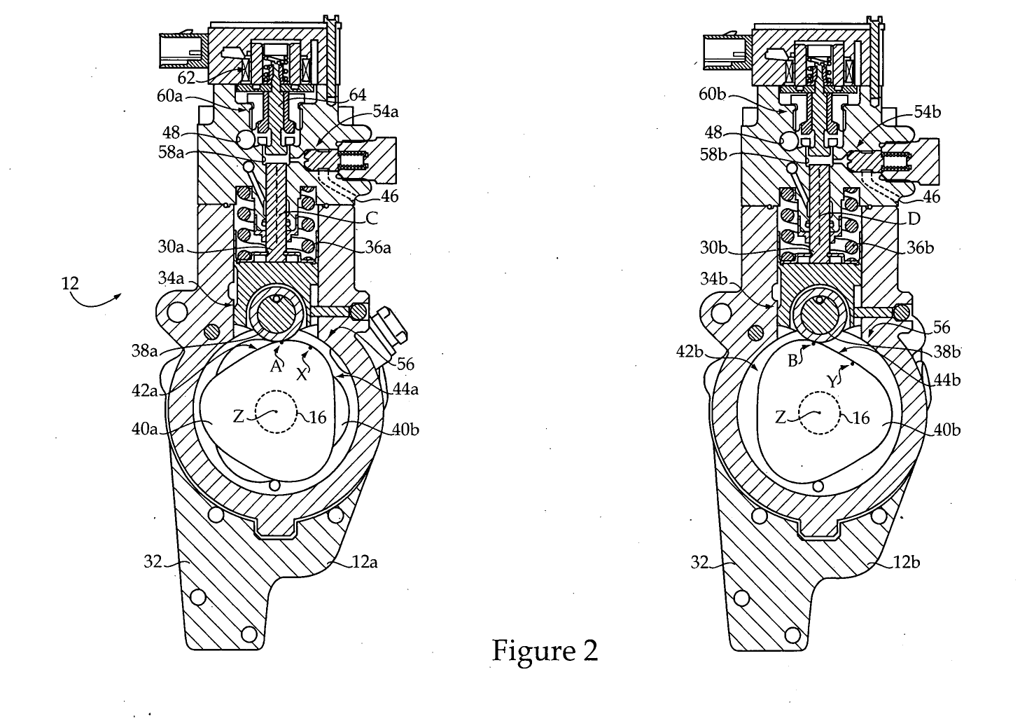

Turning now to FIG. 2, there is shown fuel pump 12 in a broken view illustrating a first fuel pump portion 12a and a second fuel pump portion 12b. In one embodiment, camshaft 16 may include an axis of rotation Z. Each of plungers 30a and 30b may include an axis of reciprocation, C and D respectively, which are also center axes of pump chambers 58a and 58b. Axes C and D may lie in a common plane which intersects axis Z and is parallel to axis Z. Thus, in the FIG. 2 illustration, pump portion 12a may be understood as a first portion of pump 12 which lies relatively closer to pump gear 28 when fuel pump 12 is installed on engine 18, whereas second pump portion 12b may be understood as a portion of fuel pump 12 which lies relatively further from pump gear 28 when fuel pump 12 is installed on engine 18. As described above, camshaft 16 may include a plurality of cams. In one embodiment, first cam 40a is associated with first pump portion 12a, whereas second cam 40b is associated with second pump portion 12b. Second cam 40b is visible behind first cam 40a in the depiction of first pump portion 12a shown in FIG. 2. Rotation of camshaft 16 can rotate cams 40a and 40b to move the corresponding plungers 30a and 30b, respectively, up and down in the FIG. 2 illustration along axes C and D. Also shown in FIG. 2 are first lifter-roller assembly 34a and second lifter-roller assembly 34b. Each lifter-roller assembly 34a and 34b may include a roller 38a and 38b, respectively, which is a cam follower that rotates against the corresponding cam 40a and 40b, respectively. Each lifter-roller assembly 34a and 34b may further include a lifter spring 36a and 36b, respectively, which biases the corresponding lifter-roller assembly 34a, 34b toward interaction with the corresponding cam 40a and 40b.

In one embodiment, pump 12 may include a first spill valve assembly 60a associated with first pump portion 12a, and a second spill valve assembly 60b associated with second pump portion 12b. Spill valve assemblies 60a and 60b may be identical in one embodiment. Fuel pump 12 may be an outlet metered pump. To this end, fuel pump 12 may include metering valves 54a and 54b, which are configured to fluidly connect a corresponding one of pump chambers 58a and 58b with outlet 46 to supply pressurized fuel to common rail 14. In certain embodiments, outlet 46 might be one outlet for one of pump portions 12a and 12b, and fuel pump 12 could include another fuel outlet for the other of pump portions 12a and 12b. Each spill valve assembly 60a and 60b may include an electrical actuator 62 which is configured to move plunger 64 to selectively block fluid communications between fuel inlet 48 and the corresponding pump chamber 58a and 58b. This general operating principle for an outlet metered pump is known in the art.

Fuel pump 12 may further include an installation assist mechanism 56 which includes lifter springs 36a and 36b, and also includes cams 40a and 40b. In one embodiment, installation assist mechanism 56 is configured to bias fuel pump 12 toward a pump configuration which is rotationally stable. It has been discovered that for certain types of fuel pumps, of which fuel pump 12 is one example, camshaft 16 will tend to always seek a position of balanced moments about axis of rotation Z when no external rotation force is acting on camshaft 16. This phenomenon may be leveraged to assist in timing pump 12 for installation on engine 18. It may be noted that fuel pump 12 is free from fixture interaction surfaces and the like, such as are used in other pumps to enable a fixture to engage with and lock a fuel pump camshaft or other components at a given orientation. Installation assist mechanism 56 enables fuel pump 12 to be installed without the need for interaction with a fixture to lock a position of camshaft 16, and without the need for specialized installation tools. Thus, the term “installation assist mechanism” as used herein should be understood to refer only to features or components of a fuel pump which are not used to interact with a fixture, timing tool, etc. For example, a fuel pump having a threaded bore in its camshaft for engaging with a set screw would, without more, not fairly be said to include an installation assist mechanism as contemplated herein.

It may further be noted that each of cams 40a and 40b has a symmetrical profile. Each of cams 40a and 40b may further be identical to one another, but positioned in fuel pump 12 about 180° out of phase relative to one another. As a consequence of the relative phasing, when one of plungers 30a and 30b is at a maximum lift position, the other of plungers 30a and 30b is at a minimum lift position. In other words, when one plunger is ascending, the other plunger 30a, 30b is descending. Each plunger 30a and 30b is reciprocated via a motion of the corresponding lifter-roller assembly 34a and 34b. Each lifter-roller assembly 34a and 34b is biased against the corresponding cam 40a and 40b via spring loads of lifter springs 36a and 36b, respectively. Rollers 38a and 38b contact cams 40a and 40b, respectively, to react this load. Since cams 40a and 40b have symmetrical profiles and are about 180° out of phase, the point at which moments about camshaft 16 sum to zero, or are balanced, is a point where one of rollers 38a and 38b exerts a force on its corresponding cam 40a and 40b at a location which is balanced by a force exerted by the other of rollers 38a and 38b at a different location on its corresponding cam 40a and 40b, as further described herein.

In the illustration of FIG. 2, roller 38a is contacting cam 40a at a midpoint A of an ascending profile 42a of cam 40a. In other words, assuming for example that camshaft 16 is rotating counterclockwise in FIG. 2, roller 38a contacts a midpoint A of ascending profile 42a, and plunger 30a is about one half way through a pumping stroke. Roller 38b contacts a midpoint B of a descending profile 44b of cam 40b, and thus plunger 30b is about one half way through an intake stroke. Cam 40a may include a descending profile 44a which adjoins ascending profile 42a, whereas cam 40b may include an ascending profile 42b which adjoins descending profile 44b. It should be understood that the terms descending and ascending are illustrative only, and in certain embodiments the orientation of fuel pump 12 when installed on engine 18 might result in different portions of cams 40a and 40b being considered an ascending profile or a descending profile than that which is shown in FIG. 2. Likewise, different cam designs might have different profiles than those illustrated, and thus the pump state for certain pumps where moments about the camshaft are balanced might appear different than that depicted for pump 12 in FIG. 2.

As mentioned above, fuel pump 12 has a rotationally balanced configuration, corresponding to the balanced moment configuration approximately as shown in FIG. 2. Accordingly, when no forces are acting on camshaft 16 other than the spring loads of lifter springs 36a and 36b, fuel pump 12 will have a tendency to settle to the configuration illustrated in FIG. 2, where moments on camshaft 16 about axis Z are balanced. In other words, when no rotational forces are applied to camshaft 16 it will always tend to settle to the configuration shown in FIG. 2, or a complementary configuration. It will be appreciated that another rotationally stable configuration for pump 12 might include a configuration where camshaft 16 is rotated about 180° from the camshaft angle illustrated in FIG. 2. Fuel pump 12 may also have a plurality of rotationally unstable configurations, that is where rotational forces of lifter springs 36a and 36b acting on camshaft 16 via lifter-roller assemblies 34a and 34b are unbalanced. For instance, if fuel pump 12 were rotated from the configuration shown in FIG. 2, such that rollers 38a and 38b contacted their corresponding cams 40a and 40b at points which separate the respective ascending and descending profiles, fuel pump 12 would be considered to be in a configuration where camshaft 16 is rotationally unstable. In FIG. 2, a point X is shown on the profile of cam 40a, and a point Y is shown on the profile of cam 40b. If camshaft 16 were rotated counterclockwise from the configuration shown in FIG. 2, to a configuration where rollers 38a and 38b contacted their corresponding cams 40a and 40b at points X and Y respectively, fuel pump 12 would be in a configuration where camshaft 16 is rotationally unstable.

### INDUSTRIAL APPLICABILITY

As alluded to above, the described self locating feature of fuel pump 12 may be leveraged to ensure that installation on engine 18 occurs at an appropriate timing between fuel pump 12 and engine 18. A typical process of setting up engine system 10 for operation, either during factory installation of fuel pump 12, or after fuel pump 12 has been removed for servicing engine system 10 and is to be reinstalled on engine 18, may begin by setting fuel pump 12 at a pump configuration for installation. FIG. 1 illustrates fuel pump 12 in an installed state on engine 18, and also in an uninstalled state, where 12′ corresponds to fuel pump 12, camshaft 16′ corresponds with camshaft 16, and lifter-roller assemblies 34a′ and 34b′ correspond with lifter-roller assemblies 34a and 34b. In each of the installed state and uninstalled state illustrated in FIG. 1, pump 12, 12′ is shown in a pump configuration where camshaft 16, 16′ is rotationally stable.

When camshaft 16 is rotationally stable, an angular location of camshaft 16, or one of a plurality of angular configurations where camshaft 16 is rotationally stable, may be known. In other words, since fuel pump 12 will tend to always self-adjust via forces of lifter springs 36a and 36b, the camshaft angle corresponding to a rotationally stable configuration of camshaft 16 is ascertainable. In the case of fuel pump 12, two rotationally stable configurations about 180° of camshaft angle from one another may exist. For purposes of phasing fuel pump 12 relative to engine 18, these two rotationally stable configurations may be considered equivalent. When set at the pump configuration where camshaft 16 is rotationally stable, pump gear 28 may be fixed at a desired timing angle relative to camshaft 16, for example by using a fixture or the like to rotate or set pump gear 28 at a desired timing angle. In many engine systems, a desired timing precision of a camshaft relative to an engine crankshaft may be a precision which is greater than the precision available by coupling gear teeth of a pump gear with the engine geartrain. In other words, it may be desirable to fix pump gear 28 with camshaft 16 within a range of angles which is finer than the angle between adjacent gear teeth on pump gear 28.

Once pump gear 28 is fixed at a desired timing angle relative to camshaft 16, with fuel pump 12 in a pump configuration where camshaft 16 is rotatably stable, engine 18 may be placed at an engine timing state which is accordant with the pump configuration. In other words, setting up engine system 10 for operation may include placing engine 18 at an engine timing state which is compatible with the pump configuration where camshaft 16 is rotationally stable. It will be recalled that setting a timing between fuel pump 12 and engine 18 may establish a relative timing of certain engine events relative to certain fuel pump events. Placing engine 18 at the engine timing state which is accordant with the rotationally stable pump configuration should be understood to mean that engine 18 is placed at an engine timing state where engine events which take place at the engine timing state will not interfere with or compromise operation of fuel pump 12 or otherwise result in undesired operation of engine system 10. For instance, it may be desirable to set the relative timing between fuel pump 12 and engine 18 such that supplying fuel from fuel pump 12 to common rail 14 occurs only when none of fuel injectors 23 is injecting fuel. Thus, placing engine 18 at a crank angle which would result in supplying fuel to common rail 14 during a fuel injection event would be an example of an engine timing state which is not accordant with the pump configuration where camshaft 16 is rotationally stable.

With engine 18 at the accordant engine timing state and fuel pump 12 in the pump configuration where camshaft 16 is rotationally stable, fuel pump 12 may be installed on engine 18. Installing fuel pump 12 on engine 18 may set a timing between engine 18 and fuel pump 12, since coupling pump gear 28 with geartrain 26 may effectively fix the relative positions between camshaft 16 and crankshaft 24. In one embodiment, the timing set between engine 18 and fuel pump 12 may be an asynchronous timing, where at least one of pistons 20 is out of phase relative to each of plungers 30a and 30b. In one further embodiment, engine 18 may be located at an engine timing state such that at least one of pistons 20 is located about 90° out of phase with respect to each of plungers 30a and 30b.

Setting up engine system 10 for operation according to the present disclosure may take place at the factory when engine system 10 is prepared for initial service. In addition, the self timing feature of fuel pump 12 may be used when installing fuel pump 12 as a replacement part for another fuel pump in an engine system, and may also be used when fuel pump 12 needs to be removed from engine 18 for servicing, then reinstalled. Installation of fuel pump 12 to engine 18 in the manner described herein is contemplated to reduce timing errors between fuel pump 12 and engine 18 during installation. By biasing fuel pump 12 via installation assist mechanism 56 toward its pump configuration where camshaft 16 is rotationally stable, and placing engine 18 at an engine timing state which is accordant with the pump configuration where camshaft 16 is rotationally stable, it may be unnecessary to utilize a secondary means for timing fuel pump 12. In other words, the unwieldy, inconvenient and labor intensive hardware and timing methods of earlier timing strategies may be dispensed with.

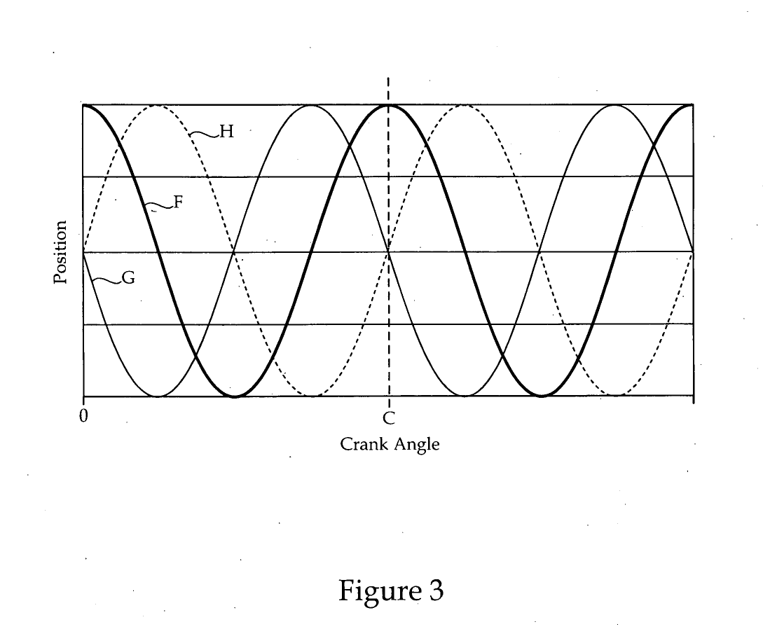

Turning now to FIG. 3, there is shown a graph which illustrates certain aspects of engine timing as compared with pump timing. In FIG. 3, the Y-axis represents position whereas the X-axis represents crank angle. Line F illustrates a position of one of pistons 20 relative to a position of first plunger 30a, line G, and relative to second plunger 30b, line H. It will be noted that plungers 30a and 30b are approximately 180° out of phase relative to one another. It may further be noted that each of plungers 30a and 30b is about 90° out of phase with respect to the selected piston. When developing an installation method according to the present disclosure, a crank angle may be selected for engine 18 where at least one piston 20 of engine 18 is out of phase, for example 90° out of phase, with each of plungers 30a and 30b.

Numerous crank angles may exist where at least one piston 20 is out of phase with respect to each of plungers 30a and 30b. Numerous crank angles may also exist where more than one of pistons 20 is out of phase with respect to each of plungers 30a and 30b. For purposes of convenience and reliability and repeatability of the installation procedure, it may be desirable to select an easily ascertainable crank angle. In one embodiment, engine 18 may be set for installation of fuel pump 12 at a crank angle where the piston 20 associated with a first one of cylinders 22 (cylinder “I”) is at a top dead center position. In FIG. 3, a crank angle θ is shown which corresponds to a crank angle where a piston 20 associated, for example, with the first one of cylinders, is at a top dead center position. It will be noted that the position of each of plungers 30a and 30b, as represented via lines G and H, are half way through an intake stroke and a pumping stroke, respectively. This configuration corresponds approximately to the configuration of pump 12 shown in FIG. 2, and represents one asynchronous timing relationship between fuel pump 12 and engine 18 where fuel pump 12 may be uninstalled and/or installed to engine 18, in accordance with the present disclosure. Where fuel pump 12 is removed from engine 18, then reinstalled, fuel pump 12 may be decoupled from engine 18, engine 18 serviced, then set at the selected crank angle θ and fuel pump 12 reinstalled on engine 18. Installation assist mechanism 56 may be used to ensure that fuel pump 12 settles to the pump configuration which is rotationally stable, and with which the selected engine crank angle θ corresponds.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects and features will be apparent upon an examination of the attached drawings and appended claims.

What is claimed is:

1. A method of setting up a common rail internal combustion engine system for operation, the method comprising the steps of:
setting a fuel pump for a common rail of the engine system at a pump configuration where a camshaft of the fuel pump is rotationally stable;
placing an engine of the engine system at an engine timing state which is accordant with the pump configuration;
installing the fuel pump on the engine when the fuel pump is in the pump configuration and the engine is at the engine timing state; and
setting a timing between the engine and the fuel pump at an asynchronous timing at least in part via the installing step.

2. The method of claim 1 wherein the step of placing the engine further includes locating at least one piston of the engine out of phase relative to at least two plungers of the fuel pump.

3. The method of claim 2 wherein the step of installing the fuel pump further includes coupling a pump gear of the fuel pump with a geartain of the engine, and wherein the step of setting the timing further includes fixing the pump gear at a timing angle relative to the camshaft when the fuel pump is in the pump configuration and prior to the installing step.

4. The method of claim 2 wherein the at least two plungers of the fuel pump include a first plunger and a second plunger, the first plunger being about 180° out of phase with respect to the second plunger, and wherein the step of locating the at least one piston out of phase includes locating the at least one piston about 90° out of phase with respect to each of the first plunger and the second plunger.

5. The method of claim 4 wherein each of the at least two plungers is coupled with a lifter-roller assembly having a lifter spring, and further including a step of biasing the fuel pump toward the pump configuration via each of the lifter springs.

6. The method of claim 5 wherein the camshaft comprises a plurality of cams corresponding one with each of the lifter-roller assemblies, and wherein the step of setting the fuel pump includes setting the fuel pump at the pump configuration where a roller of a first lifter-roller assembly contacts a midpoint of an ascending profile of a first one of the cams and a roller of a second lifter-roller assembly contacts a midpoint of a descending profile of a second one of the cams.

7. The method of claim 2 wherein the fuel pump includes an outlet metered pump, and wherein the installing step further includes establishing a first fluid connection between an outlet of the fuel pump and the common rail of the engine system and establishing a second fluid connection between an inlet of the fuel pump and a low pressure fuel supply of the engine system.

8. The method of claim 2 wherein the step of placing the engine at the engine timing state includes positioning a piston of the engine at a top dead center position.

9. An electronically controlled variable displacement fuel pump for a common rail fuel system of an internal combustion engine comprising:
a housing having a fuel inlet and a fuel outlet;
a metering valve associated with the housing and configured to vary an output of the fuel pump to a common rail;
a camshaft having a plurality of cams;
a plurality of plungers; and
a plurality of biasers each biasing one of the plurality of plungers toward interaction with one of the plurality of cams;
wherein the fuel pump has a pump configuration where the camshaft is rotationally stable, the fuel pump further including an installation assist mechanism which includes the plurality of biasers and the plurality of cams and is configured to bias the fuel pump toward the pump configuration.

10. The fuel pump of claim 9 wherein the plurality of plungers includes a first plunger and a second plunger, the second plunger being about 180° out of phase with respect to the first plunger, and further including a plurality of lifter-roller assemblies which each have a lifter spring including one of the biasers.

11. The fuel pump of claim 10 wherein the plurality of cams includes a first cam and a second cam, each of the first and second cams including an ascending profile having a midpoint and a descending profile also having a midpoint, and wherein the plurality of lifter-roller assemblies includes a first lifter-roller assembly contacting the midpoint of the ascending profile of the first cam when the fuel pump is in the pump configuration and a second lifter-roller assembly contacting the midpoint of the descending profile of the second cam when the fuel pump is in the pump configuration.

12. The fuel pump of claim 11 wherein the housing defines a plurality of pump chambers each having a center axis, and wherein the center axes of the pump chambers are positioned in a common plane, the camshaft further including an axis of rotation positioned in the common plane.

13. The fuel pump of claim 12 wherein the metering valve includes an outlet metering valve positioned fluidly between one of the pump chambers and the fuel outlet.

14. A method of reducing timing errors of a fuel pump in a common rail engine system, the method comprising the steps of:
biasing the fuel pump toward a pump configuration where a camshaft of the fuel pump is rotationally stable;
placing an engine at an engine timing state which is accordant with the pump configuration;
installing the fuel pump on the engine when the fuel pump is in the pump configuration and the engine is at the engine timing state; and
setting a timing between the engine and the fuel pump at an asynchronous timing at least in part via the installing step.

15. The method of claim 14 further including selecting one of a plurality of crank angles for the engine where at least one piston of the engine is out of phase with respect to at least two plungers of the fuel pump, wherein the step of placing the engine at the engine timing state includes placing the engine at the selected crank angle.

16. The method of claim 15 wherein the biasing step includes biasing the fuel pump toward the pump configuration at least in part via a plurality of lifter springs of a plurality of lifter-roller assemblies each coupled between one of a plurality of plungers of the fuel pump and one of a plurality of cams of the camshaft.

17. The method of claim 16 wherein the biasing step further includes biasing the fuel pump toward the pump configuration where biasing forces of the lifter springs acting on the camshaft sum to zero.

18. The method of claim 17 wherein the installing step further includes coupling a pump gear of the fuel pump with a geartrain of the engine without locking the camshaft against rotation.

19. The method of claim 18 further including decoupling the fuel pump from the engine, prior to the step of placing the engine at the first engine timing state, and wherein the decoupling step includes decoupling the fuel pump from the engine without locking the camshaft against rotation.
